(19) United States
(12) Patent Application Publication
(10) Pub. No.: US 2022/0277304 A1
(43) Pub. Date: Sep. 1, 2022

(54) Systems and Methods for Sanction Management

(71) Applicant: JPMorgan Chase Bank, N.A., New York, NY (US)

(72) Inventors: Roy E. Knighton, JR., Elmhurst, IL (US); Kuresh Rahmanian, Tampa, FL (US); Thomas M. Rizzo, Apollo Beach, FL (US)

(21) Appl. No.: 15/398,245

(22) Filed: Jan. 4, 2017

(51) Int. Cl. G06Q 20/40

(52) U.S. Cl. CPC G06Q 20/405

(57) ABSTRACT

Systems and methods for sanction management are disclosed. In one embodiment a method may include a server: (1) receiving a transaction from a transaction source; (2) receiving decisioning on a sanction status of the transaction; (3) storing the transaction and the decisioning for the transaction in an active database; and (4) moving the transaction and decisioning for the transaction to an archive database after a first period of time. According to another embodiment, a method may include a server: (1) receiving an inquiry for a transaction that has a sanction status; (2) querying an active database for the transaction; (3) querying an archive database for the transaction in response to the transaction not being located in the active database; (4) retrieving the transaction and decisioning for the transaction from the archive database into the active database; and (5) presenting the transaction and decisioning for the transaction on an interface.

### BACKGROUND OF THE INVENTION

### 1. Field of the Invention

The present invention generally relates to systems and methods for sanction management.

### 2. Description of the Related Art

The United States Office of Foreign Assets Control (“OFAC”) administers and enforces economic sanctions programs primarily against countries and groups of individuals, such as terrorists and narcotics traffickers. Prohibited transactions are trade or financial transactions and other dealings in which U.S. persons may not engage unless authorized by OFAC or expressly exempted by statute.

In order for financial institutions to comply with these programs, the parties of a transaction are compared against a number of sanction lists, including the “Specially Designated Nationals” (“SDN”) that identifies individuals and companies that U.S. persons are generally prohibited from dealing with.

### SUMMARY OF THE INVENTION

Systems and methods for sanction management are disclosed. In one embodiment a method for managing sanction-reviewed transactions may include (1) receiving, at a server comprising at least one computer processor, a transaction from a transaction source; (2) receiving, at the server, decisioning on a sanction status of the transaction; (3) the server storing the transaction and the decisioning for the transaction in an active database; and (4) the server moving the transaction and decisioning for the transaction to an archive database after a first period of time.

In one embodiment, the transaction source may include a payment application.

In one embodiment, the decisioning on the sanction status may include a manual decision and/or an automated decision.

In one embodiment, the first period of time may be determined dynamically based on a volume of transactions stored on the active database and/or based on a recovery policy for the active server.

In one embodiment,, the first period of time may be fixed.

In one embodiment, the method may further include the server moving the transaction and decisioning for the transaction to cold storage after a second period of time

According to another embodiment, a method for managing sanction-reviewed transactions may include (1) receiving, at a server comprising at least one computer processor, an inquiry for a transaction that has a sanction status; (2) the server querying an active database for the transaction; (3) the server querying an archive database for the transaction in response to the transaction not being located in the active database; (4) the server retrieving the transaction and decisioning for the transaction from the archive database into the active database; and (5) the server presenting the transaction and decisioning for the transaction on an interface.

In one embodiment, the decisioning on the sanction status may include a manual decision and/or an automated decision.

In one embodiment, the method may further include the server moving the transaction and decisioning on the transaction back to the archive database after a first period of time.

In one embodiment, the inquiry may include an identification of a party to the transaction.

According to another embodiment, a system for managing sanction-reviewed transactions is disclosed. The system may include a transaction source; an active database; an archive database; and a server comprising a computer processor. The server may receive a transaction from the transaction source and decisioning on a sanction status of the transaction. It may then store the transaction and the decisioning for the transaction in the active database. It may then move the transaction and decisioning for the transaction to the archive database after a first period of time.

The server may also receive via an interface an inquiry for a second transaction that has a sanction status, query the active database for the second transaction; query the archive database for the second transaction in response to the second transaction not being located in the active database; retrieve the second transaction and decisioning for the second transaction from the archive database into the active database; and present the second transaction and decisioning for the second transaction on the interface.

In one embodiment, the transaction source may include a payment application.

In one embodiment, the first period of time may be determined dynamically based on at least one of a volume of transactions stored on the active database and a recovery policy for the active server, or it may be fixed.

In one embodiment, the server may move the second transaction and decisioning on the second transaction back to the archive database after a first period of time.

In one embodiment, the inquiry may include an identification of a party to the transaction.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for sanction management according to one embodiment;

FIG. 2 depicts a method for managing sanction-reviewed transactions according to one embodiment; and

FIG. 3 depicts a method for sanction-reviewed transactions according to another embodiment.

### DETAILED DESCRIPTION OF PREFERRED EMBODIMENTS

Embodiments disclosed herein are directed to systems and methods for sanction management.

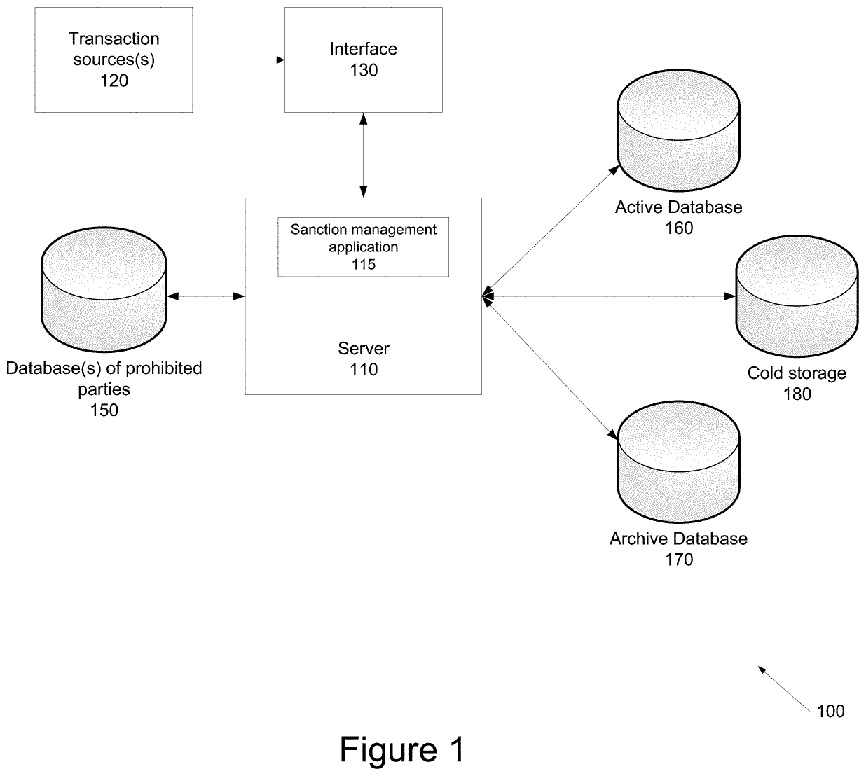

FIG. 1 depicts a system for sanction management according to one embodiment. System 100 may include server 110, one or more databases of prohibited individuals, groups, and entities 150, one or more interface 130 for reviewing transactions, active database 160, and archive database 170.

In one embodiment, server 110 may execute sanction management application 115. In one embodiment, server 110 may be hosted by a financial institution. In one embodiment, sanction management application 115 may receive transactions from one or more transaction source 120, which may include, for example, various payment applications.

Database 150 may be public (e.g., government) or private. An example of database 150 may include the Specialty Designated Nationals (SDN) list, available from the Office of Foreign Assets Control (OFAC) of the U.S. Treasury. Other databases, lists, etc. may be used as is necessary and/or desired.

After transactions are received and reviewed, the transaction and the decisioning associated therewith (collectively, “transaction data”) may be stored in active database 160. In one embodiment, transaction data may remain in active database 160 for a first period of time (e.g., 3 months, 6 months, etc.) after which they may be stored in archive database 170 for a second period of time. In one embodiment, after the second period of time, the transaction data may be purged, moved to deep archive storage, etc. In another embodiment, the transaction data may be retained indefinitely.

In one embodiment, active database 160 may be limited to storing a certain number of transaction data. This may result in a fast retrieval of transaction data compared to retrieval of transaction data from archive database 170.

In one embodiment, both active database 160 and archive database 170 may be online at all times. Active database 160 may include all of the active cases and the resolved cases which have been resolved within the first period of time. Transaction data for resolved cases may be moved to archive database 170 after they have been revolved for the first time period.

In one embodiment, transaction data that is stored in archive database 170 may only be viewed, and no actions can be taken on them unless the case is moved back to active database 160.

Any suitable time periods may be used as is necessary and/or desired. In one embodiment, one or both of the time periods may depend on the volume of transactions, policies, laws, and regulations, anticipated need for retrieving archived transactions, etc.

In one embodiment, sanction management program 115 may control the archiving and retrieval of transaction data to and from archive database 170 and active database 160.

In one embodiment, cold storage 180 may be provided. Transaction data may be moved from archive database 170 into cold storage 180. Transaction details for cases in cold storage 180 may be viewed in, for example, report form, but cannot be brought back to active database 160 for additional actions.

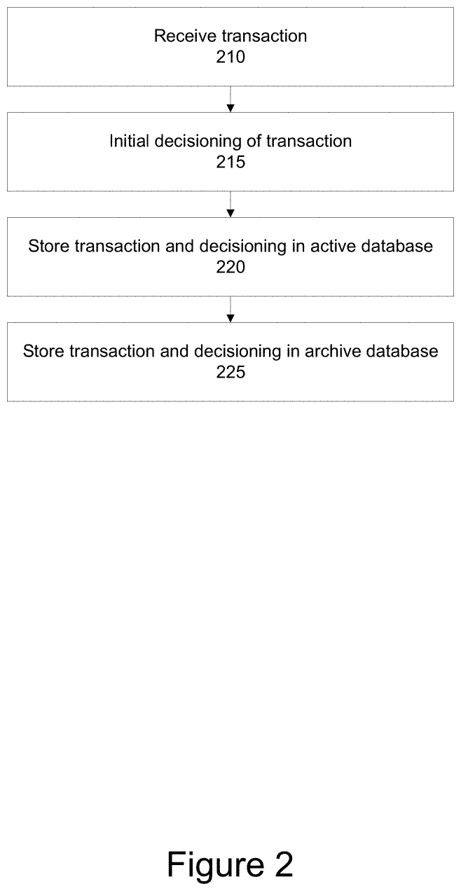

FIG. 2 depicts a method for sanction-reviewed transactions according to one embodiment. In step 210, a transaction may be received. In one embodiment, the transaction may be any sort of financial transaction involving an account of a customer of the financial institution that hosts the sanction management application. In one embodiment, the transaction may be received from a transaction source, such as a payment application. Any other suitable transaction source may be used as is necessary and/or desired.

In step 215, the transaction may be reviewed and decisioned to determine if it should be allowed or blocked. In one embodiment, the sanction management program may retrieve data on prohibited persons, groups, and/or entities from public databases (e.g., the SDN list) may be consulted. In addition, other lists, such as organization-specific lists, may be consulted as necessary and/or desired.

In step 220, transaction data may be stored in an active database.

In step 225, after a first time period, the transaction data may be stored in an archive database. In one embodiment, after a second time period, the transaction data may be purged, moved to deep archive storage, etc.

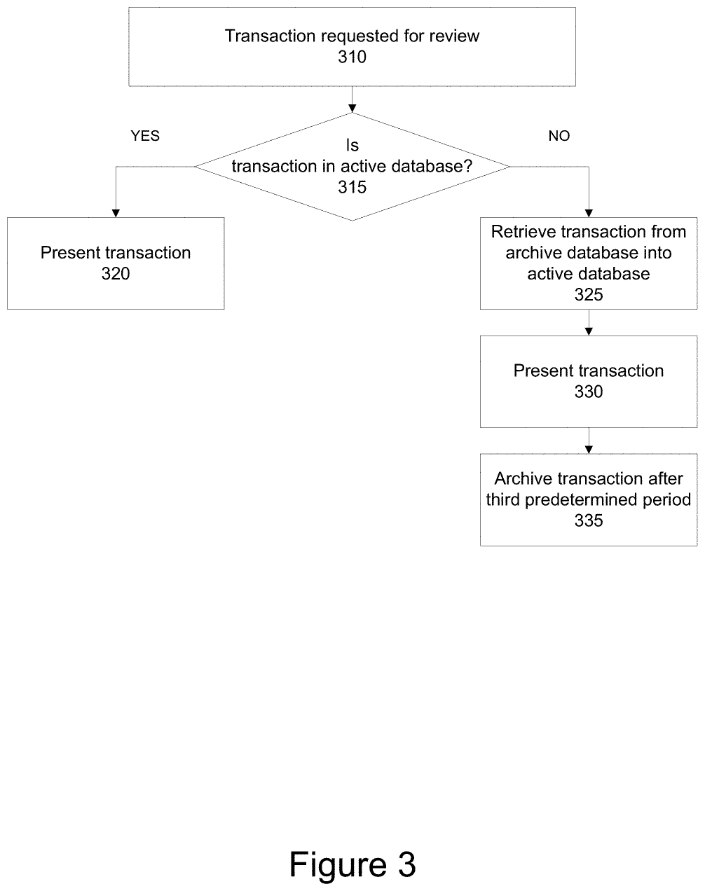

Referring to FIG. 3, a method for sanction-reviewed transactions is disclosed according to another embodiment.

In step 310, a request may be received to review a transaction. For example, the request may be made by an analyst using an interface.

In step 315, the system may determine whether the transaction is located in the active database. This may involve, for example, querying the active database with a transaction identifier, a party, or any other relevant information. If the transaction is located, in step 320, the transaction data may be presented, for example, on the interface.

If transaction data is not located in the active database, in step 325, the archive database may be searched for the transaction, and the transaction data may be retrieved to the active database. In step 330, the transaction data may be presented (similar to step 320).

In step 335, after a third time period, the transaction data may be moved back to the archive database. In one embodiment, the third time period may be the same as the first time period (e.g., 3 months); in another embodiment, it may be different (e.g., 7 days). Any suitable time periods may be used as is necessary and/or desired.

In one embodiment, some or all of the time periods may be dynamic and may be based on the volume of transactions that are stored on the active database, organizational policies, etc. For example, an organization may require certain performance from the active database (e.g., speed at which the transaction is identified, time to recover the active database in case of failure, etc.). Thus, any or all of the time periods may be dynamically determined based on these, or other, requirements.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for implementing dynamic data storage for sanction- reviewed transactions, comprising:
receiving, at a server comprising at least one computer processor, a plurality of transactions from a transaction source;
retrieving, by the server, from one of a public database and one or more organization-specific lists, decisioning on a sanction status associated with one or more transactions from the plurality of transactions;
storing, by the server, the plurality of transactions and the decisioning for the one or more transactions in an active database, wherein the active database stores transactions for which the sanction status decisioning has not been received and the one or more transactions for which one or more respective sanction status decisionings has been received within a first time period;
moving, by the server, the one or more transactions and the one or more respective sanction status decisionings to an archive database after the first period of time;
moving, by the server, the one or more transactions and the one or more respective sanction status decisionings to cold storage from the archive database after a second period of time, wherein the one or more transactions and the one or more respective sanction status decisionings are not movable to the active database after being moved to the cold storage;
dynamically changing, by the server, the first period of time based on volume of transactions and the second period of time based on anticipated need for retrieving archived transactions;
receiving, at the server, a request to review a transaction;
searching the active database for the requested transaction;
in response to determining that the requested transaction is not stored in the active database, searching the archive database for the requested transaction;
in response to finding the requested transaction in the archive database, retrieving transaction data of the requested transaction and automatically moving storage of the transaction data of the requested transaction from the archive database to the active database for a third period of time so that only transaction data that are younger than the first period of time and the transaction data of the requested transaction are stored in the active database for selective storage of currently relevant data, the third period of time being at least one week; and
moving the transaction data of the requested transaction back to the archive database after passing of the third period of time.

2. The method of claim 1, wherein the transaction source comprises a payment application.

3. The method of claim 1, wherein the decisioning on the sanction status comprises a manual decision.

4. The method of claim 1, wherein the decisioning on the sanction status comprises an automated decision.

5. (canceled)

6. The method of claim 1, wherein the first period of time is determined dynamically based on a recovery policy for the active server.

7-13. (Cancelled).

14. A system for implementing dynamic data storage for sanction-reviewed transactions, comprising:
a transaction source;
an active database;
an archive database;
a cold storage; and
a server, comprising at least one computer processor, running a sanction management program, the server being configured to:
receive a plurality of transactions from the transaction source;
receive, from the sanction management program, decisioning on a sanction status of each of the plurality of transactions;
store the plurality of transactions and one or more decisioning for one or more transactions received within a first period of time, in the active database;
move the one or more decisioning and the corresponding one or more transactions to the archive database after the first period of time;
move the one or more transactions and the corresponding one or more decisionings to cold storage from the archive database after a second period of time, wherein the one or more transactions and the corresponding one or more decisionings are not movable to the active database after being moved to the cold storage; [[and]]
dynamically change the first period of time based on volume of transactions and the second period of time based on anticipated need for retrieving archived transactions;
receive a request to review a transaction;
search the active database for the requested transaction;
in response to determining that the requested transaction is not stored in the active database, search the archive database for the requested transaction;
in response to finding the requested transaction in the archive database, retrieve transaction data of the requested transaction and automatically move storage of the transaction data of the requested transaction from the archive database to the active database for a third period of time so that only transaction data that are younger than the first period of time and the transaction data of the requested transaction are stored in the active database for selective storage of currently relevant data, the third period of time being at least one week; and
move the transaction data of the requested transaction back to the archive database after passing of the third period of time.

15. (canceled)

16. The system of claim 14, wherein the transaction source comprises a payment application.

17. The system of claim 14, wherein the first period of time is determined dynamically based on a recovery policy for the active server.

18. The system of claim 14 wherein the first period of time is fixed.

19. The system of claim 14, wherein the third period of time, corresponding to the length of time the one or more transactions and the corresponding one or more decisionings are stored in the active database after being retrieved from the archived database, is predetermined.

20. (canceled)

21. The method of claim 1, wherein the third period of time is same as the first period of time.

22. The method of claim 1, wherein the third period of time is less than the first period of time.

23. The method of claim 1, wherein the third period of time is at least three months.
